(19) United States
(12) Patent Application Publication
(10) Pub. No.: US 2012/0210594 A1
(43) Pub. Date: Aug. 23, 2012

(54) ERGONOMIC DUAL TOWEL

(76) Inventor: Norman Heyman, Henderson, NV (US)

(21) Appl. No.: 13/400,368

(22) Filed: Feb. 20, 2012

Related U.S. Application Data
(60) Provisional application No. 61/463,726, filed on Feb. 22, 2011.

(51) Int. Cl. A45D 20/00; F26B 19/00

(52) U.S. Cl. 34/283; 34/90

(57) ABSTRACT

An ergonomic dual bath towel assembly used to dry simultaneously both the hair and torso of a bather includes a large body towel and a smaller towel for the hair connected by elastic straps to a larger body towel, which is located spaced apart from the smaller hair towel, thereby freeing the neck and upper shoulder area of the bather from being constricted by the wrapped towels. The two towels are used together and the straps keep the shoulders and neck in the un-encumbered spaced apart region while the hair is drying with the smaller towel and the body is dried by the larger towel. The free region between the head and the torso does not constrict the face, neck and upper shoulder areas while the user is drying the hair and torso/legs with the larger towel.

### RELATED APPLICATIONS

This application claims benefit and priority of provisional application Ser. No. 61/463,726 filed Feb. 22, 2011 under 35 U.S.C. §119(e), which application is incorporated by reference herein.

### FIELD OF THE INVENTION

The invention relates to a combination bath towel assembly, and more specifically to a combination bath towel assembly used to dry simultaneously both the hair and torso of a bather.

### BACKGROUND OF THE INVENTION

Towels generally are available in a variety of sizes and rectangular shapes to cater to various end uses. Bath towels are sized to be used for drying after bathing; they generally wrap around the torso.

The patent application of Stein, US 2009/0144874, describes a wearable towel having a preferred embodiment with two openings strategically positioned to secure the towel to the body of the wearer using one arm. In other embodiments, the openings in the towel are replaced by fabric straps engaged at distal ends forming handle-like openings. Yet other embodiments show the use of small multiple through holes along the periphery of the towel at regular intervals engaging such strap handles or small sections of triangularly-shaped towel material with openings via chain-like clips and links through peripheral holes. In yet other embodiments, the main towel is extended in length and area by appending other same-width sections at the edge (conjoining towels) as by sewing.

The invention of Stein does not serve the function of the combination towel of the current invention since it does not have the requisite features to simultaneously dry the hair and torso of a bather.

### OBJECTS OF THE INVENTION

It is therefore an object of the present invention to provide an ergonomic a combination bath towel assembly used to dry simultaneously both the hair and torso of a bather.

It is also an object of the present invention to provide a dual towel with a smaller towel for the hair connected by elastic straps to a larger body towel, which is located spaced apart from the smaller hair towel, thereby freeing the neck and upper shoulder area of the bather.

Other objects which become apparent from the following description of the present invention.

### SUMMARY OF THE INVENTION

In one example of the invention, the ergonomic combination dual bath towel assembly includes one smaller towel utilized for drying the hair of a bather; a second larger towel for drying the torso of a bather; and an attachment means for joining the smaller towel to the larger towel in spaced-apart fashion. The attachment means a plurality of elastic bands providing for a selectable gap or span between the towels. The attachment bands may be secured to one or both towel sections permanently as by sewing, or they may be removable at one or both ends from the respective towel sections by the use of fasteners such as snaps, hook and loop sections, or buttons and button holes. They can overlap and be fastened to a face of the respective towel or they can be attached to the peripheral edge thereof.

In an alternate embodiment, the bands for attachment of the two towel sections are not elastic; they do not stretch. To provide the necessary distance between the two towel sections, longer bands, or straps, are used.

In a further alternate embodiment, an optional veil is provided over the elastic or non-elastic bands or straps, or in place of the bands or straps. The veil is preferably a fabric or other flexible membrane that covers or replaces the bands or straps. Optionally the veil can assume the shape of a fanciful image, such as a character, such as a butterfly, that includes elastic wings attached to the small and larger towels, to provide the special gap therebetween. The fanciful image can be any fanciful image, including but not limited to a rose, a heart, a Christmas wreath and the like. In a further alternate embodiment the veil in the form of the character, such as a butterfly, including two panels that are stitched together and encompass or surround the existing straps. This provides a safety feature, by prevent a potential choking hazard since the gap between the straps would be spanned and closed by the veil. Further optionally the fanciful image of the veil can be a sports logo.

The ergonomic features of the combination dual towel of this invention include the location on both towel sections of the attachment bands, their elasticity and/or length, and the size of each towel section. The location of the one or two attachment bands is at the central edge of one long side of the large bath towel permits this section to be wrapped around the torso unencumbered. The corresponding attachment location at the distal end of the one or more bands at the lower edge of the smaller towel section permits movement to dry the hair and to wrap the hair at will without pulling at the neck or shoulder regions.

Note that the cited prior art application of Stein '874 does not support the ergonomic features described above since the overall geometry is a large rectangular towel with no spaced-apart second smaller towel section strategically attached to facilitate drying of the hair with the possibility of unencumbered wrapping.

### BRIEF DESCRIPTION OF THE FIGURES

The preferred and alternative embodiments of the present invention are described in detail below with reference to the following drawings, in which:

FIG. 1 is a perspective view of the combination bath towel assembly as worn by a bather after exiting a bath;

FIG. 2 is a perspective view of the combination bath towel assembly in a flat condition;

FIG. 3 is an enlarged perspective view, taken at arrow 3 of FIG. 2, of the attachment means providing a spaced apart region between the small and large towels of the present invention, according to a preferred embodiment of the present invention;

FIG. 4 is a perspective view of the attachment means of FIG. 3 when worn by a bather;

FIG. 5 is a local perspective view of a first alternate embodiment of the attachment means;

FIG. 6 is a local perspective view of a second alternate embodiment of the attachment means;

FIG. 7 is a perspective view of a third alternate embodiment for a veil spanning the spatial gap between the towels of the dual towel assembly, wherein the veil is in an unstretched mode;

FIG. 8 is a perspective view of the alternate embodiment of FIG. 7, for a veil spanning the spatial gap between the towels of the dual towel assembly, wherein the veil is in an outstretched mode; and,

FIG. 9 is a perspective view of a fourth alternate embodiment where a veil covers the bands or straps connecting the small and large towels of the dual towel assembly.

### DETAILED DESCRIPTION OF THE INVENTION

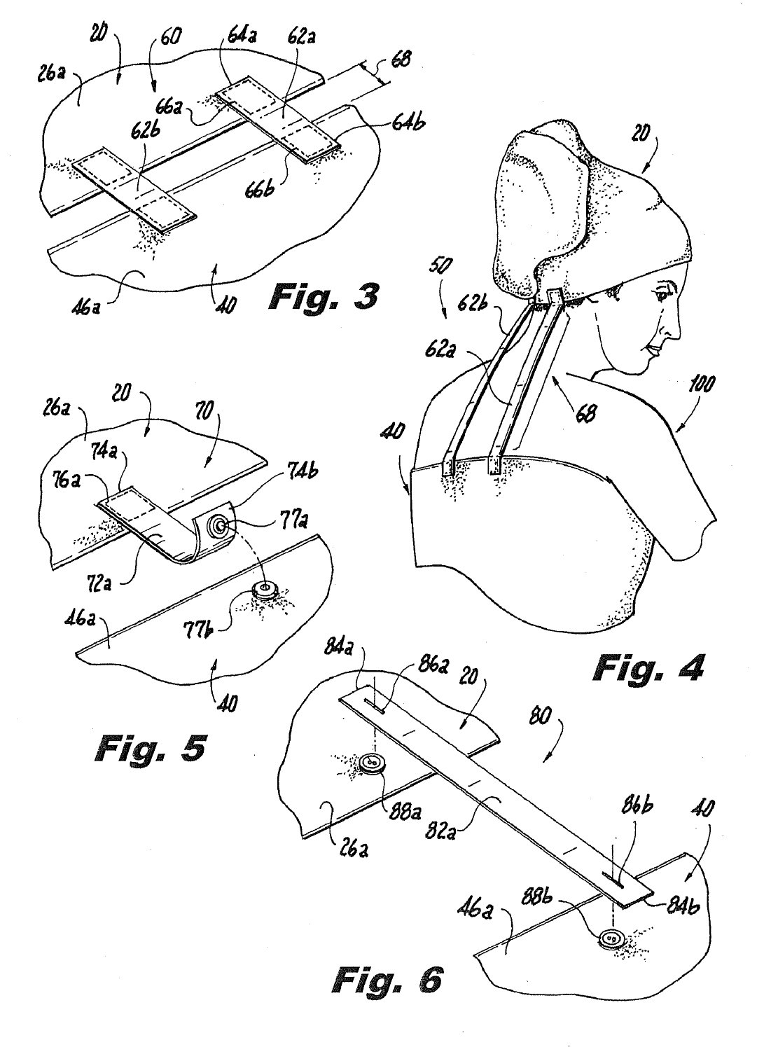

As seen in FIG. 1, combination dual bath towel assembly includes one smaller towel 20 utilized for drying the hair of a bather 100; a second larger towel 40 for drying the torso of the bather 100; an attachment means spanning a gap between smaller towel 20 and larger towel 40 for joining the smaller towel 20 to the larger towel 40 in spaced-apart fashion. As shown in FIGS. 3-5, the attachment means is comprised of a plurality of elastic bands 62a, 62b providing for a selectable gap or span 68 between the towels 20,40, to allow an unencumbered region in the vicinity of the bather 100's neck and shoulder region, so that the neck, shoulders and arms of the bather 100 are free to move while drying and are not constricted, as would be the case in a hooded towel or single towel. The attachment bands 62a, 62b may be secured to one or both towel sections 20, 40 permanently as by sewing, or they may be removable at one or both ends from the respective towel sections by the use of fasteners such as snaps (FIG. 5), hook and loop sections, or buttons and button holes (FIG. 6).

In an alternate embodiment, the bands 62a, 62b for attachment of the two towel sections 20, 40 are not elastic; they do not stretch. To provide the necessary distance between the two towel sections, longer bands 62a, 62b, or straps are used.

The ergonomic features of the combination dual towel of this invention include the location on both towel sections 20, 40 of the attachment bands 62a, 62b, their elasticity and/or length, the size of the spatial gap 68 therebetween and the size of each towel section 20, 40. The location of the one or two attachment bands 62a, 62b is preferably at the central edge of one long side of the large bath towel 40 permits this section 40 to be wrapped around the torso of the bather 100 unencumbered. The corresponding attachment location at the distal end of the one or more bands 62a, 62b at the lower edge of the smaller towel section 20 and the spatial gap 68 provided therebetween permits movement of the shoulders, arms and neck of the bather 100 to dry the hair and to wrap the hair at will without a pulling at the neck or shoulder regions.

FIG. 1 further shows the combination towel assembly 10 being worn by bather 100 who is shown having recently exited a bath tub. The bath towel assembly 10 includes small towel 20, typically utilized for wrapping and drying the bather's hair, and a larger towel 40, typically utilized for wrapping and drying the body of the bather 100.

As shown in FIG. 4, smaller towel 20 and large towel 40 are shown affixed to each other as at the neck and shoulder region 50 of the bather 100, by attachment means, generally designated 60, so that small towel 20 and larger towel 40 are spaced apart from each other in region 50. By affixing towel 20 to towel 40 in a spaced apart relationship via attachment means 60, the bather 100 is assured of the availability and usage of both towels 20 and 40 upon exiting the bath or shower.

As further shown in FIG. 1, in use, larger towel 40 can be worn and maintained on the body as a modesty wrap, where towel 40 is wrapped along its larger edge so that its two opposite smaller edges are drawn toward each other as larger towel 40 is wrapped around the bather 100's torso, while smaller towel 20, spaced apart from larger towel 40 by attachment means 60, continues to absorb moisture from the bather 100's hair during other activities. Small towel 20 and large towel 40 are preferably formed of a soft, absorbent material such as cotton; however, other materials could be contemplated such as cotton blends, polyesters, wool or other absorbent fabric materials.

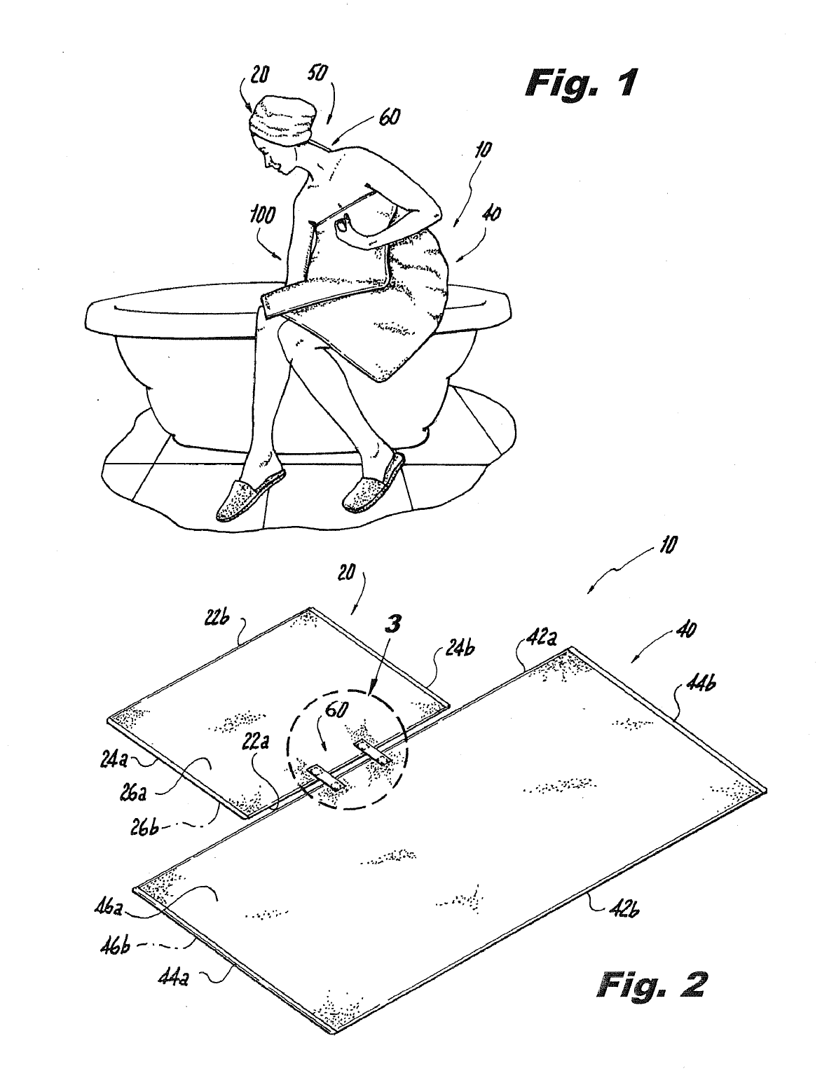

When the attachment bands 62a and 62b are unstretched, as seen in FIGS. 2 and 3, gap 68 between the two towels may be small. However, preferably, the gap 68 therebetween is larger, such as shown in FIG. 4, either when stretched, or provided with a large gap 68 to begin with.

As also shown in FIG. 2, dual bath towel assembly 10 shows smaller towel 20 being rectangular in shape, with two long sides 22a and 22b, and two shorter sides 24a and 24b. Also shown in FIG. 2 is upward facing surface 26a, while surface 26b faces downward. Smaller towel 20 is shown as preferably rectangular in shape; however, other shapes such as square, ovoid, or trapezoid could be contemplated. Larger towel 40 is shown adjacent but spaced apart from towel 20, and is also preferably rectangular in shape, with two long sides 42a and 42b and two short sides 44a and 44b. FIG. 2 also shows upward facing surface 46a, while surface 46b faces downward. Large towel 40 is shown as preferably rectangular in shape; however, other shapes such as square, ovoid, or trapezoid could be contemplated. FIG. 2 also shows attachment means 60, which joins towel 20 to towel 40 in a spaced apart configuration, optionally in a permanent attachment, such as by sewing.

Attachment means 60 providing spatial gap 68 is shown in FIG. 3, which is an enlarged view taken at arrow 3 of FIG. 2. As shown in this view, attachment means 60 includes two bands 62a and 62b, preferably formed of an elastic material, which provide an unencumbered region 50 in the vicinity of the user's neck, shoulders and arms. In this embodiment, bands 62a and 62b have end portions 64a and 64b. End portions 64a and 64b are shown permanently affixed to corresponding towel surfaces 26a and 46a via stitching 66a and 66b with gap 68 spanning therebetween. Bands 662a and 62b, upon attachment to towels 20 and 40, have an elastic capability in the span 68 between the stitching 64a and 64b. The elastic capability, as at span 68, permits towel 20 to be selectively spaced from towel 40 when utilized by bather 100, as in FIG. 4, but also facilitates storage of smaller towel 20 within larger towel 40 when in a folded condition, as on a closet shelf. Additionally, elastic bands 62a and 62b insure that towels 20 and 40 will maintain their conjoined relationship during washing and drying. While two elastic bands are illustrated to affix towel 20 to towel 40, other means could be contemplated such as, but not limited to, a single band, an array of bands, an elastic cord, or a combination thereof.

An alternative method of an attachment means 70 is shown in FIG. 5. In this view, only one elastic band 72a is illustrated. It is contemplated that band 72a could be used in cooperation with one or more other bands or cords, or could function singularly. The features of band 72a allow towel 20 to be selectively separated from towel 40. Band 72a has an end portion 74a, which is shown permanently affixed to surface 26a of towel 20 via stitch 76a. The opposite end 74b of band 72a incorporates male snap member 77a which could be adhered or stitched to band end 74b. As shown in the view, male snap member 77a will be received by female snap member 77b, which is disposed on surface 46a of towel 40 and affixed with an adhesive or a stitch. In this embodiment, towel 20 can be selectively removed from towel 40 at the whim of the bather, while insuring band 72a is secured to towel 20. Alternatively, band 72a could be provided with other means for releasable engagement at end 74b, such as, but not limited to, hook and loop hardware, magnets, clips and hook/loop tape. Additionally, these means for releasable engagement could be contemplated for band end 74a, while maintaining permanent fixation at end 74b, or having releasable means disposed at both ends of band 72a.

FIG. 6 shows still another alternate attachment means 80. In this view, only one band 82a is shown but it is contemplated that band 82a could be used in combination with other means, or singularly, as in the previously described embodiment. Band 82a as shown in FIG. 6 is an elongated strap, containing no elastic properties. Since the strap is fabricated from non-stretchable material such as cotton, polyester, or even leather, it must be of sufficient length to allow towel 20 to be used in a spaced part configuration by gap 68 from larger towel 40 in the neck and shoulder region 50, as best seen in FIG. 4. Band 82a has ends 84a and 84b, each end having corresponding button holes 86a and 86b. Button hole 86a receives button 88a, disposed on surface 26a of towel 20, and button hole 86b receives button 88b, disposed on surface 46a of towel 40. In this way towel 20 and towel 40 can be maintained in a conjoined but spaced apart relationship, while having the ability to remove band 82a completely, or leaving it secured to either towel 20 or towel 40. While button holes and buttons are the preferred attachment means shown in FIG. 6, other suitable means may be contemplated, such as, but not limited to, hook and loop hardware, clips, magnets, zippers or hook/loop tape.

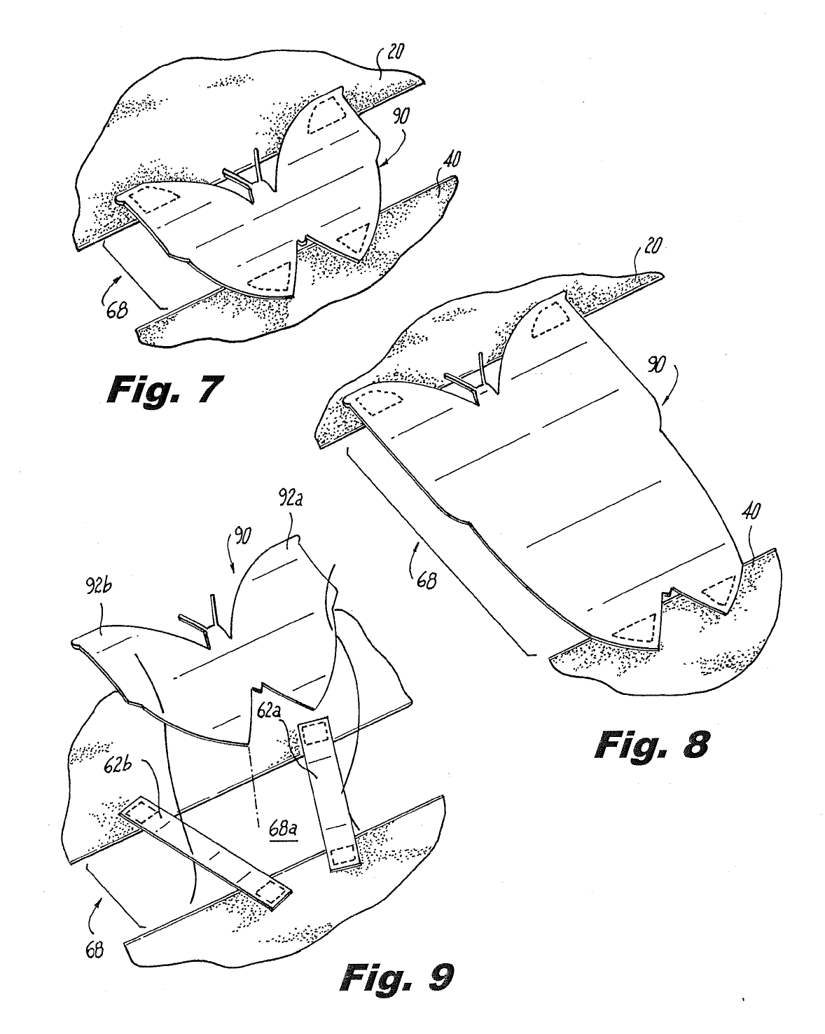

As shown in FIGS. 7-9, in a further alternate embodiment, an optional veil 90 is provided over the elastic or non-elastic bands or straps 62a, 62b, or in place of the bands or straps. Veil 90 is preferably a fabric or other flexible membrane that covers or replaces the bands or straps 62a, 62b. Optionally veil 90 can assume the shape of a character, such as a butterfly, that includes elastic wings 92a, 92b attached to the small and larger towels 20, 40, to provide the special gap 68 therebetween. FIG. 7 shows veil 90 in an unstretched mode. FIG. 8 shows veil 90 is a stretched mode, enlarging gap 68 between small towel 20 and larger towel 40. In a further alternate embodiment shown in FIG. 9, veil 90, in the form of the character, such as a butterfly, includes both wing panels 92a, 92b which cover bands or straps 62a, 62b. Veil 90 can also wrap around and optional enclose bands or straps 62a, 62b. The use of veil 90, either in place of bands or straps 62a, 62b, or covering bands or straps 62a, 62b, provides a safety feature, by preventing a potential choking hazard since the gap mid portion 68a of gap 68 between the bands or straps 62a, 62b is spanned and closed by the veil 90. It is further noted that the fanciful image of veil 90 can be any fanciful image, including but not limited to, a rose, a heart, a Christmas wreath and the like.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. An ergonomic dual towel comprising:
first and second spaced towel members;
said first towel member comprising a towel which is sized and adapted to enclose a head for drying a user head of hair;
said second towel member comprising a towel which is sized and adapted to swath a torso of said user; and
means for attaching together said first and second towel members in a spaced apart manner to allow said towel members to independently cover the head and torso, respectively, of said user while providing a spaced apart region without a towel in the vicinity of the neck and shoulders of said user, thereby allowing the shoulders and arms of said user to not be constrictive and to allow free movement of said shoulders and arms.

2. The towel of claim 1 in which said first towel member is substantially smaller than said second towel member.

3. The towel of claim 2 in which said attaching means comprises at least one elastic band which elongates to accommodate the head and torso configuration of the user.

4. The towel of claim 3 in which said attachment means comprises multiple elastic bands to elongate independently of each other to accommodate the head and torso configuration of the user.

5. The towel of claim 3 in which said elastic band has at least one end permanently attached to a towel portion.

6. The towel of claim 3 in which said elastic band has at least one end which is releasably attached to a towel portion.

7. The towel of claim 3 in which the releasable attachment is a snap.

8. The towel of claim 4 in which the releasable attachment is by hook and loop connection.

9. The towel of claim 1 wherein said means for attaching together said first and second towel members in a manner to allow said towel members to independently cover the head and torso, respectively, of said user while allowing shoulders and arms of said user to not be constrictive and allow free movement of said shoulders and arms comprises a flexible veil spanning said spaced apart region without a towel in the vicinity of the neck and shoulders of said user.

10. The towel of claim 9 wherein said flexible veil is elastic.

11. The towel of claim 10 wherein said flexible veil has the shape of a fanciful image.

12. The towel of claim 10 wherein said fanciful image is a character.

13. The towel of claim 10 wherein said fanciful image of the veil is a sports logo.

14. The towel of claim 9 wherein said veil covers at least one elastic band connecting said first and second towel members.

15. A method of toweling comprising the steps of:
providing first and second spaced towel members, said first towel member comprising a towel which is sized and adapted to enclose a head for drying a user head of hair, and said second towel member comprising a towel which is sized and adapted to swath a torso of said user;
attaching together said first and second towel members in a manner to allow said towel members to be adapted to said head and torso of said user independently of each other;
providing a spaced apart region without a towel in the vicinity of the neck and shoulders of said user, thereby allowing the shoulders and arms of said user to not be constrictive and to allow free movement of said shoulders and arms; and,
said user covering his or her head and torso with said first and second towel members, respectively, while allowing shoulders and arms of said user to not be constrictive and allow free movement of said shoulders and arms.

16. The method of claim 15 in which said first towel member is substantially smaller than said second towel member.

17. The towel of claim 16 in which said attaching means comprises at least one elastic band which elongates to accommodate the head and torso configuration of the user.

18. The method of claim 17 in which said attachment means comprises multiple elastic bands to elongate independently of each other to accommodate the head and torso configuration of the user.

19. The method of claim 17 in which said elastic band has at least one end permanently attached to a towel portion.

20. The method of claim 17 in which said elastic band has at least one end which is releasably attached to a towel portion.

21. The method of claim 17 in which the releasable attachment is a snap.

22. The method of claim 17 in which the releasable attachment is by hook and loop connection.

23. The method of claim 17 further comprising the step of providing a flexible veil spanning said spaced apart region without a towel in the vicinity of the neck and shoulders of said user.

24. The method as in claim 23 wherein said flexible veil is elastic.

25. The method as in claim 23 wherein said flexible veil has the shape of a fanciful image.

26. The method as in claim 23 wherein said fanciful image is a character.

27. The method as in claim 23 wherein said fanciful image of the veil is a sports logo.
